(19) United States
(12) Patent Application Publication
(10) Pub. No.: US 2011/0235929 A1
(43) Pub. Date: Sep. 29, 2011

(54) METHOD AND APPARATUS FOR IMAGE ENCODING

(76) Inventors: Hiroki MIZOSOE, Kawasaki (JP); Hironori Komi, Tokyo (JP); Yusuke Yatabe, Yokohama (JP); Tomoyuki Myojin, Tsuchiura (JP); Mitsuhiro Okada, Yokohama (JP)

(21) Appl. No.: 12/909,489

(22) Filed: Oct. 21, 2010

(30) Foreign Application Priority Data
Mar. 26, 2010 (JP) 2010-071670

(51) Int. Cl. G06T 9/00

(52) U.S. Cl. 382/236

(57) ABSTRACT

An image encoding method for encoding an image using intra coding and interframe coding is offered. A refreshing area in which image refreshing is performed by intra coding is established. The refreshing area is shifted in an equal increment every frame such that the refreshing area traverses through the whole frame periodically. Where a macroblock that have passed through the refreshing area is interframe coded, a motion compensation vector of the macroblock is selected such that an image which has passed through the refreshing area is referenced.

### INCORPORATION BY REFERENCE

The present application claims priority from Japanese application JP2010-071670 filed on Mach 26, 2010, the content of which is hereby incorporated by reference into this application.

### BACKGROUND OF THE INVENTION

The present invention relates to a method and apparatus for encoding images.

Motion picture encoding making use of intra coding and interframe coding is in general use. During the process when encoded motion pictures are transmitted to a receiver side through a transmission path, code errors may be produced due to transmission errors. Where encoding is being performed using interframe coding, if code errors as described above take place, the errors may be kept propagated to ensuing images. Accordingly, this propagation may be prevented by inserting an intra-coded image at regular intervals. This is known as refresh.

On the other hand, intra coding generally produces a larger amount of code than interframe coding. Therefore, portions using intra coding and portions using interframe coding are greatly different in amount of code. In practice, transfer rates often have their upper limits and so it is necessary to suppress the peak value of the amount of code generated. Consequently, this creates the problem that the image quality is deteriorated.

JP-A-7-322266 discloses a technique for setting a refreshing area in a portion of each image to minimize the amount of locally generated code.

### SUMMARY OF THE INVENTION

In the technique of the above-cited JP-A-7-322266, motion compensation relying on interframe coding is also taken into account. That is, the refreshing area is shifted every frame such that the amount of overlap between any two successive refreshing areas is in excess of a motion compensation range. This prevents the refreshed block from referring to not-yet refreshed pixels; otherwise, errors would be transferred further.

However, the amount of overlap exceeds the motion compensation range at all times and so the refreshing areas become wider greatly. This produces the problem that the amount of locally generated code increases. In addition, the amount of shift decreases relatively and, therefore, it takes longer for the refreshing area to make a round through the whole screen. This poses the problem that it takes longer to perform a restoration on occurrence of an error.

To solve the foregoing problem, a method is offered which encodes an image using intra coding and interframe coding and which has the following features. A refreshing area in which image refreshing is performed by intra coding is shifted in an equal increment every frame such that the refreshing area traverses through the whole frame periodically. When a macroblock having passed through the refreshing area is interframe coded, a motion compensation vector of the macroblock is selected such that an image having passed through the refreshing area is referenced.

The means described above make it unnecessary that the amount of overlap invariably exceed the motion compensation range when the refreshing area is shifted. Consequently, the refreshing area does not need to be broadened excessively. Accordingly, increase of locally generated amount of code may be suppressed to a minimum. Hence, the image quality may be improved.

Because it is not necessary to relatively reduce the amount of shift of the refreshing area, it may take shorter for the refreshing area to make a round through the whole screen. On occurrence of an error, a restoration may be performed quickly.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram illustrating an encoding apparatus;

FIG. 2 is a flowchart illustrating a sequence of operations performed by a control portion 111 shown in FIG. 1;

FIG. 3 illustrates a method of restricting a motion search range;

FIG. 4 is a block diagram illustrating another encoding apparatus; and

FIG. 5 is a flowchart illustrating a sequence of operations performed by a control portion 111 shown in FIG. 4.

### DESCRIPTION OF THE EMBODIMENTS

Embodiments are hereinafter described.

### Embodiment 1

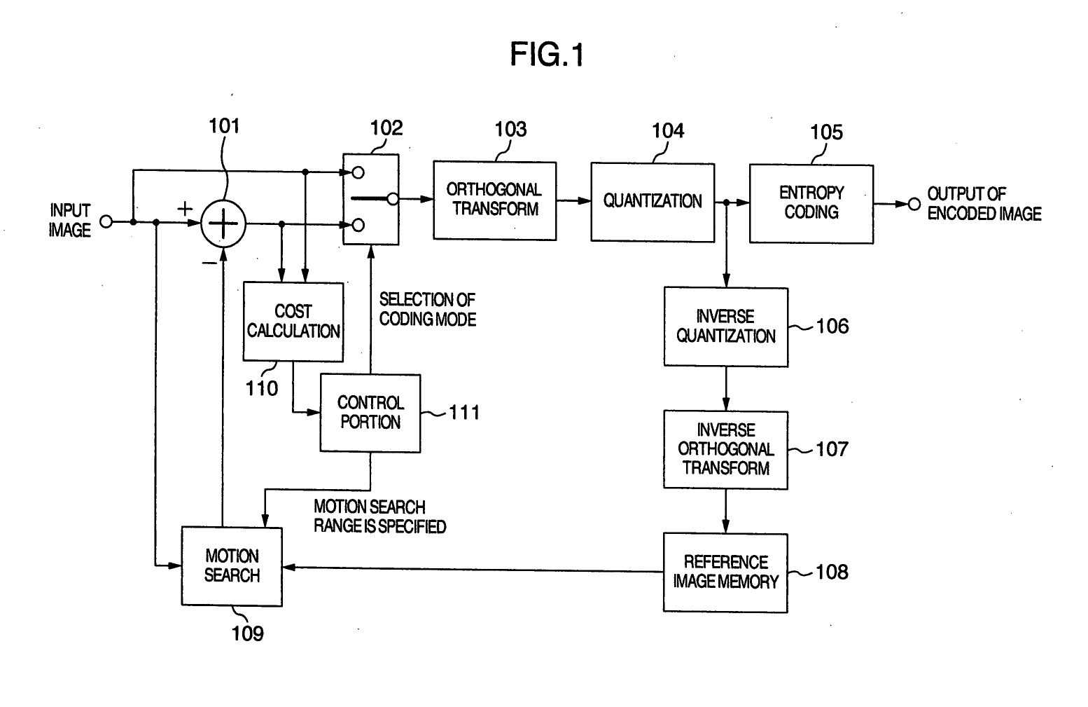

FIG. 1 is a block diagram of an encoding apparatus according to Embodiment 1. In the following description, input images are so processed that one rectangular area (macroblock) of a given size is processed at a time. Each macroblock of an input image is applied to a subtractor 101, where the difference between the macroblock and a forecast image delivered from a motion search portion 109 is found and output.

The output from the subtractor 101 and the input image are applied to a switch 102. Either one is selected for each macroblock based on an instruction from a control portion 111. That is, when an instruction for intra coding is given, the input image is selected. When an instruction for interframe coding is given, the output from the subtractor 101 is selected. The selected signal is output from the switch 102 and applied to an orthogonal transform portion 103.

The signal applied to the orthogonal transform portion 103 is converted from space domain to frequency domain by orthogonal transformation and output to the following quantization portion 104. The signal applied to the quantization portion 104 is divided by a quantization coefficient and thus quantized. The quantized signal is output from the quantization portion 104 and applied to an entropy coding portion 105 and to an inverse quantization portion 106.

The signal input to the entropy coding portion 105 is entropy coded by a code having a length corresponding to the probability of occurrence of signal and output as a coded image.

The signal input to the inverse quantization portion 106 is multiplied by a quantization coefficient. Thus, the signal is inverse quantized and output to the inverse orthogonal transform portion 107. The signal input to the inverse orthogonal transform portion 107 is converted into a signal from frequency domain to space domain by an inverse orthogonal transformation. The resulting signal is stored as a reference image for subsequent frames into a reference image memory 108.

The motion search portion 109 refers to the past reference images stored in the reference image memory 108 by a motion search process and locates a portion having a value closest to that of the microblocks of the input image. The search is conducted within a motion search range specified from the control portion 111. A forecast image, i.e., the result of the search, is input to the aforementioned subtractor 101.

A cost calculation portion 110 calculates costs of encoding (e.g., an estimated amount of generated sign) for each of the macroblocks respectively indicated by the output from the subtractor 101 and by the input image and outputs the results to the control portion 111.

The control portion 111 determines to which of refreshing area, not-yet refreshed area, and already refreshed area does the currently processed macroblock belong. The control portion also determines what coding mode of the current macroblock (MB), i.e., whether intra coding or interframe coding, depending on the output result of the cost calculation portion 110, and issues an instruction to the switch 102. Furthermore, the control portion 111 determines the motion search range according to the area to which the currently processed macroblock belongs, and issues an instruction to the motion search portion 109.

These subtractor 101, switch 102, orthogonal transform portion 103, quantization portion 104, entropy coding portion 105, inverse quantization portion 106, inverse quantization portion 107, reference image memory 108, motion search portion 109, cost calculation portion 110, control portion 111, and other components may be built as an integrated circuit acting as a processing portion that performs various kinds of processing. In this way, the encoding apparatus may be implemented in hardware.

Programs, such as subtraction program 101, switching program 102, orthogonal transform program 103, quantization program 104, entropy coding program 105, inverse quantization program 106, inverse orthogonal transform program 107, motion search program 109, and cost calculation program 110, which perform various kinds of processing and are stored in storage means (not shown) such as a memory are executed by the control portion 111. Consequently, the encoding apparatus may be implemented in software.

The operation of the control portion 111 is described in further detail.

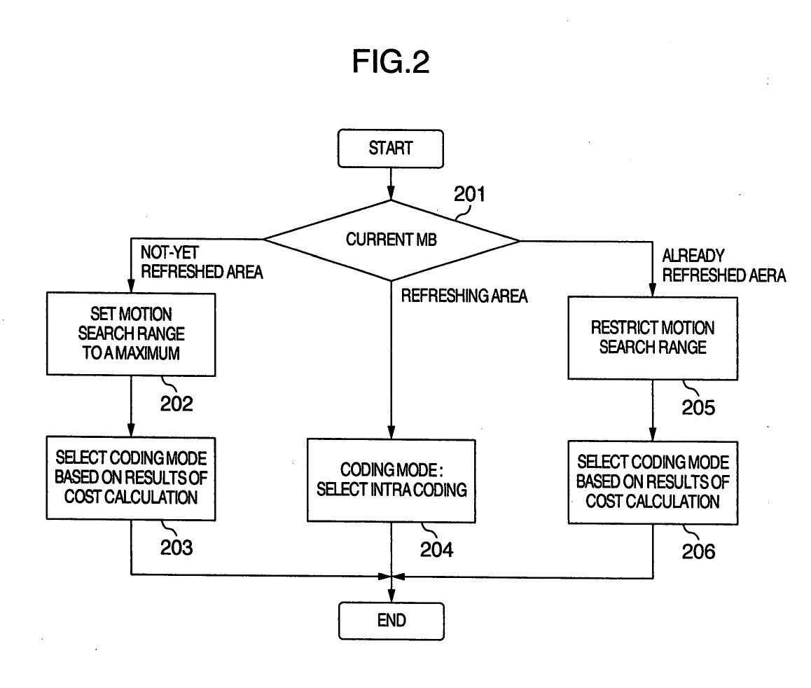

FIG. 2 is a flowchart illustrating a sequence of operations performed by the control portion 111. First, the control portion 111 determines to what area does the current macroblock (MB) belong from its position (address) (step 201). If the current macroblock belongs to a not-yet refreshed area, the control portion 111 sets a maximum area that may be processed as a motion search range by the motion search portion 109 and gives an instruction to the motion search portion 109 (step 202).

Based on the result of calculation performed by the cost calculation portion 110, the control portion 111 selects one of intra coding and interframe coding which provides a lower coding cost as the coding mode of the current macroblock and gives an instruction to the switch 102 (step 203).

Furthermore, if the current macroblock belongs to a refreshing area, the control portion 111 selects intra coding as the coding mode and issues an instruction to the switch 102 (step 204).

If the current macroblock belongs to an already refreshed area, the control portion 111 finds a motion search range that is restricted according to the position of the current macroblock to prevent the motion search portion 109 from referring to a not-yet refreshed area and gives an instruction to the motion search portion 109 (step 205).

In addition, the control portion 111 selects one of intra coding and interframe coding which provides a lower coding cost, based on the result of calculation performed by the cost calculation portion 110 and issues an instruction to the switch 102 (step 206).

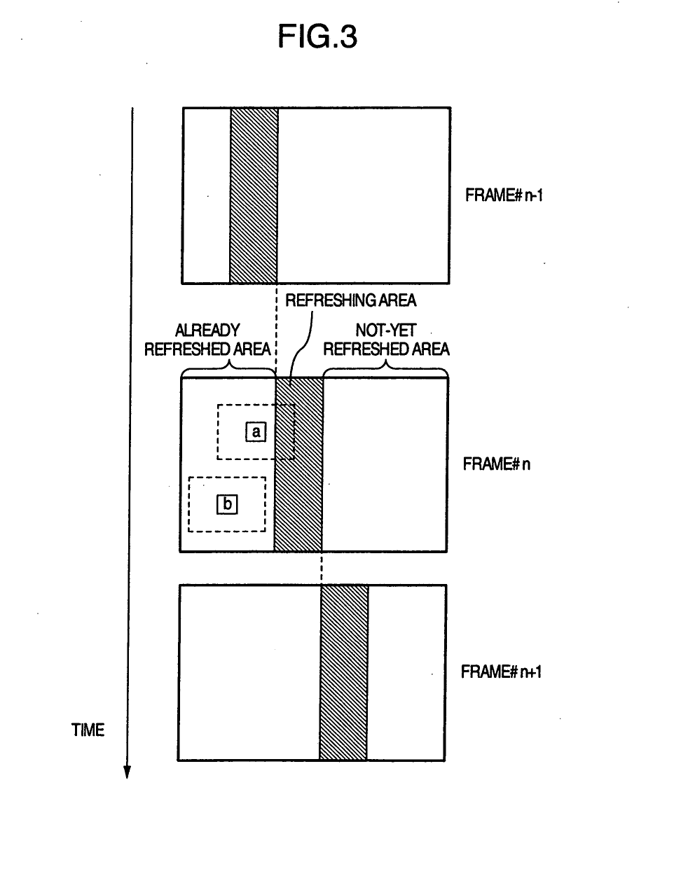

FIG. 3 illustrates a method of restricting the motion search range. The operations of the above-described step 205 are described in further detail by referring to FIG. 3, where the hatched portion is a refreshing area. It is assumed that the refreshing area is shifted to the right every frame. The frame that is currently being encoded is indicated by #n. In the frame #n, a not-yet refreshed area is located on the right side of the refreshing area, while an already refreshed area is on the left side of the refreshing area. It is also assumed that frame #(n−1) gives a reference image when the frame #n is motion-compensated.

A case in which the currently processed macroblock is in the state (a) of FIG. 3 is now discussed. The dotted line around (a) indicates a maximum area that may be searched by the motion search portion 109. In this case, a right portion of the motion search range overlaps an area other than the already refreshed area of the reference image (i.e., the refreshing area or an area corresponding to a not-yet refreshed area in the frame #n). Accordingly, the control portion 111 eliminates this overlapping area from the motion search range. The remaining, restricted area is taken as the motion search range. The control portion 111 specifies to the motion search portion 109 that the motion search range has been restricted. Consequently, whenever a motion compensation is provided, it is assured that the motion search portion refers to the already refreshed area.

Where the currently processed macroblock is in the state (b) of FIG. 3, the area surrounded by the dotted line (maximum range capable of being motion-searched) is totally within the already refreshed area. In this case, it is not necessary for the control portion 111 to restrict the motion search range.

As described so far, according to the present embodiment, when the refreshing area is shifted, it is not necessary that the amount of overlap always exceed the motion search range. Hence, the refreshing area does not need to be excessively wide. In consequence, increase of locally generated amount of sign may be suppressed to a minimum. Thus, the image quality may be improved.

Furthermore, because the amount of overlap does not need to be greater than the motion compensation range, it is not necessary to relatively reduce the amount of shift of the refreshing area. Therefore, it is possible to reduce the time taken for the refreshing area to make a round across the whole screen. Consequently, when an error occurs, a restoration may be performed quickly.

### Embodiment 2

Embodiment 2 is next described. Description of those portions of Embodiment 2 which are identical with their counterparts of Embodiment 1 is omitted, and only different portions will be described.

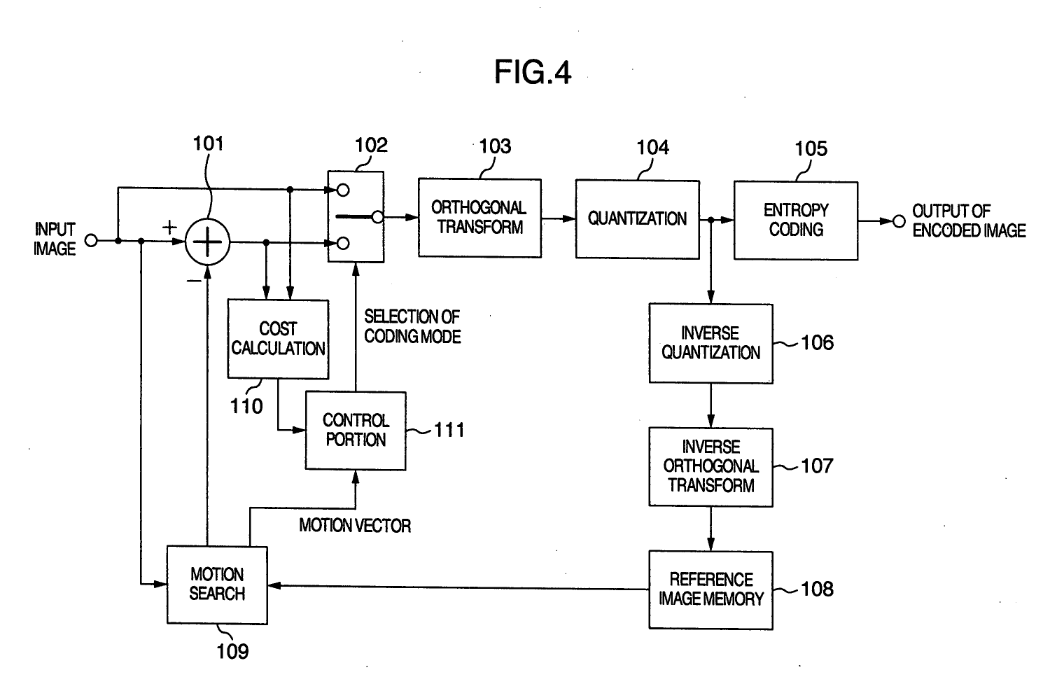

FIG. 4 is a block diagram of an encoding apparatus according to Embodiment 2. The difference with Embodiment 1 is as follows. The motion search portion 109 searches the given searchable motion search range without receiving instructions regarding restriction of the motion search range from the control portion 111, and outputs a motion vector indicating the result of the search to the control portion 111.

The control portion 111 receives the motion vector from the motion search portion 109 and determines a coding mode using the motion vector.

The encoding apparatus of FIG. 4 may be implemented either in hardware or in software, in the same way as the apparatus described in connection with FIG. 1.

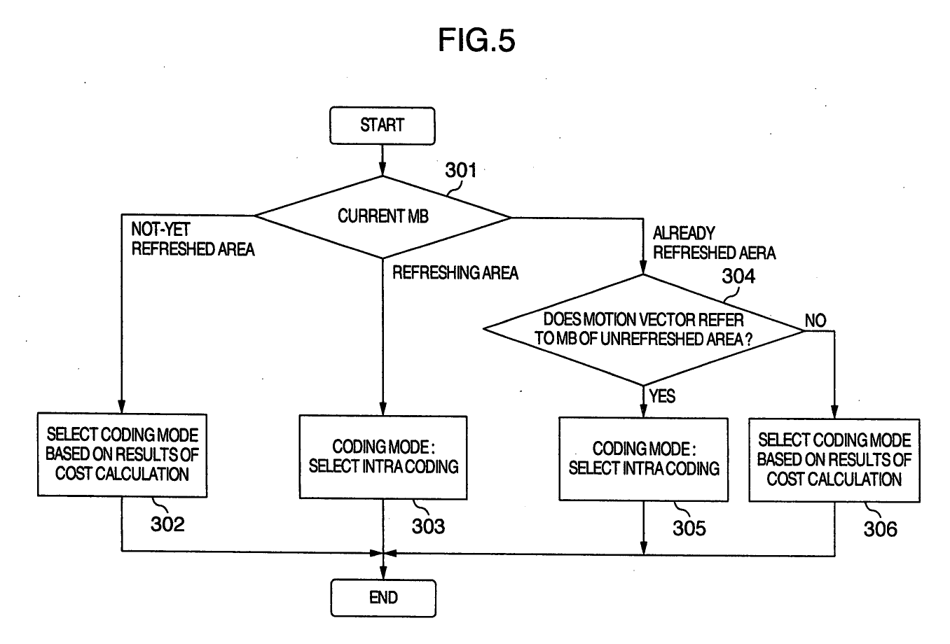

FIG. 5 is a flowchart illustrating a sequence of operations performed by the control portion 111. First, the control portion 111 determines an area to which the current macroblock (MB) belongs from its position (address) (step 301).

Where the current macroblock is a not-yet refreshed area, the control portion 111 performs an operation similar to step 203 (step 302).

Where the current macroblock is the refreshing area, the control portion 111 performs an operation similar to step 204 (step 303).

Where the current macroblock is an already refreshed area, the control portion 111 makes a decision as to whether the motion search portion 109 is referring to a not-yet refreshed area, using the motion vector delivered from the motion search portion 109 (step 304). If the result of the decision is YES, the control portion 111 selects intra coding as the coding mode and gives an instruction to the switch 102 (step 305).

If the result of the decision at step 304 is NO, the control portion 111 selects one of intra coding and interframe coding which provides a lower coding cost as the coding mode for the current macroblock, based on the result of calculation of the cost calculation portion 110, and gives an instruction to the switch 102 (step 306).

As described so far, according to the present embodiment, when a refreshing area is shifted, it is not necessary that the amount of overlap exceed the motion compensation range. This makes it unnecessary to broaden the refreshing area excessively. Accordingly, increase of locally generated amount of sign may be suppressed to a minimum. Consequently, the image quality may be improved.

Furthermore, because the amount of overlap does not need to be wider than the motion compensation range, it is not necessary to relatively reduce the amount of shift of the refreshing area. This makes it possible to reduce the time taken for the refreshing area to make a round across the whole screen. When an error occurs, a restoration may be performed quickly.

In the embodiments described so far, the refreshing area assumes the form of a vertically elongated stripe. The same advantages may be had if the area assumes the form of a laterally elongated stripe.

Furthermore, in the embodiments described thus far, when the refreshing area is shifted, no overlap takes place at all. An overlap having an arbitrary width may be introduced. In Embodiment 1, if there is an overlap, the restriction on the motion search range is moderated accordingly and so the motion compensation accuracy is improved. This leads to higher image quality. If the width of overlap is not set too large, the resulting increase of generated amount of sign may be reduced to a bare minimum.

It is to be understood that the present invention is not limited to the above embodiments but embraces various modifications. For example, the above embodiments have been described in detail such that the invention is easily understandable. The invention is not always limited to one having all the configurations described. Furthermore, some configurations of one embodiment may be replaced by configurations of other embodiment. In addition, configurations of other embodiment may be added to the configurations of one embodiment. Further, with respect to some configurations of each embodiment, other configurations may be added, deleted, or replaced.

The above-described configurations, functions, processing portions, processing means, and so on may be totally or partially implemented in hardware, for example, by designing them as an integrated circuit. Furthermore, the aforementioned configurations, functions, and so on may be implemented in software by causing a processor to interpret and execute a program that realizes the functions. Information about programs, tables, files, and so on which realize the functions may be placed either in a storage device such as a memory, hard disk, or SSD (solid-state drive) or in a storage medium such as an IC card, SD card, or DVD.

Only control lines and information lines which are considered to be necessary for explanation are shown. Not always all control lines and information lines on or in the product are shown. It may be considered that almost all configurations are interconnected in practice.

It should be further understood by those skilled in the art that although the foregoing description has been made on embodiments of the invention, the invention is not limited thereto and various changes and modifications may be made without departing from the spirit of the invention and the scope of the appended claims.

1. An image encoding method of encoding an image using intra coding and interframe coding, comprising the steps of:
shifting a refreshing area, in which image refreshing is performed by intra coding, in an equal increment every frame such that the refreshing area traverses through a whole frame periodically; and
selecting a motion compensation vector of a macroblock such that an image having passed through the refreshing area is referenced in a case where the macroblock having passed through the refreshing area is interframe coded.

2. An image encoding method of encoding an image using intra coding and interframe coding, comprising the steps of:
shifting a refreshing area, in which image refreshing is performed by intra coding, in an equal increment every frame such that the refreshing area traverses through a whole frame periodically; and
forcibly intra coding a macroblock in a case where a motion compensation vector of the macroblock is selected such that the macroblock having passed through the refreshing area refers to an image which has not yet passed through the refreshing area.

3. An image encoding apparatus for encoding an image using intra coding and interframe coding, said apparatus comprising:
motion search portion which searches a motion vector in a specified motion search range; and
control portion which selects a coding mode of a macroblock and specifies the motion search range for the motion search portion;
wherein said control portion establishes a refreshing area in which image refreshing is performed, shifts the refreshing area in an equal increment every frame such that the refreshing area traverses through a whole frame periodically, selects intra coding when the macroblock being currently processed is within the refreshing area, and specifies the motion search range to be within an image having passed through the refreshing area when the macroblock being currently processed is an area already passed by the refreshing area.

4. An image encoding apparatus for encoding an image using intra coding and interframe coding, said apparatus comprising:
motion search portion which searches a motion vector in a given motion search range; and
control portion which selects a coding mode of a macroblock;
wherein said control portion establishes a refreshing area in which image refreshing is performed, shifts the refreshing area in an equal increment every frame such that the refreshing area traverses through a whole frame periodically, selects intra coding when the macroblock being currently processed is within the refreshing area, and forcibly selects intra coding when the macroblock being currently processed is an area already crossed by the refreshing area and a motion vector indicating a result of search performed by the motion search portion refers to an image which have not yet passed through the refreshing area.
